(19) United States
(12) Patent Application Publication
(10) Pub. No.: US 2025/0108631 A1
(43) Pub. Date: Apr. 3, 2025

(54) GAS IMPINGEMENT UNIT

(71) Applicant: Canon Production Printing Holding B.V., Venlo (NL)

(72) Inventors: Hendrikus G.M. RAMACKERS, Venlo (NL); Adrianus A. DRAAD, Venlo (NL)

(73) Assignee: Canon Production Printing Holding B.V., Venlo (NL)

(21) Appl. No.: 18/981,115

(22) Filed: Dec. 13, 2024

Related U.S. Application Data
(63) Continuation of application No. PCT/EP2023/066481, filed on Jun. 19, 2023.

(30) Foreign Application Priority Data
Jun. 22, 2022 (EP) 22180376.0

(51) Int. Cl. B41J 11/00; B41J 29/377; F26B 15/18; F26B 21/00; F26B 21/08

(52) U.S. Cl. CPC B41J 11/0022; B41J 29/377; F26B 21/004; F26B 21/08; F26B 15/18

(57) ABSTRACT

A gas impingement unit includes a gas source and an array of nozzles connected to the gas source and directed onto a support and transport surface arranged for supporting sheet-or web-like media and moving them in a transport direction past the array of nozzles. The nozzles are evenly distributed over an area of the support and transport surface. The array is an array of interleaved nozzles and vent openings. The vent openings are arranged for allowing gas that has been blown out from the nozzles to escape in a direction normal to the support and transport surface.

The invention relates to a gas impingement unit comprising a gas source and an array of nozzles connected to the gas source and directed onto a support and transport surface arranged for supporting sheet-or web-like media and moving them in a transport direction past the array of nozzles, wherein the nozzles are evenly distributed over an area of the support and transport surface.

In ink jet printing, gas impingement units or, more particularly, hot air impingement units, are frequently used for subjecting printed media sheets to a drying or curing treatment. The array of nozzles extends over the entire width of a transport path for the media and extends over a certain distance in transport direction, so that a stream of hot air can be directed onto each point on the wet surface of the media for a time sufficient to cure or dry the ink as the media move underneath the nozzle array. The hot air that has been blown onto the surface of the media transfers a certain amount of heat onto the media and absorbs and carries away the water vapor (in case of water-based ink) that evaporates from the surface of the media. The air then flows off towards the edges of the nozzle array in directions parallel to the support and transport surface.

In known gas impingement units, the nozzle array takes the form of a box to which the hot air is supplied and the bottom of which is perforated by a regular pattern of holes that constitute the nozzles. An example of a gas impingement unit of this type has been described in US 2018142413 A1.

EP 3 932 680 A1 discloses an ink jet printer in which one or more air knives, each of which includes a row of nozzles, are arranged above a transport part for media sheets such that the nozzles are directed onto the edges of the sheets in order to prevent the sheet from curling.

It is an object of the present invention to provide a gas impingement unit that is capable of subjecting the media to a more efficient drying or curing treatment

It is another object of the present invention to provide a gas impingement unit that is capable of providing a more reliable media transport underneath the gas impingement unit, e.g. with a reduced risk of media jams.

In order to achieve these objects, the gas impingement unit according to the invention is characterized in that said array is an array of interleaved nozzles and vent openings, wherein the vent openings are arranged for allowing gas that has been blown out from the nozzles to escape in the direction normal to the support and transport surface.

Thanks to the vent openings that are interleaved with the nozzles, the air that has impinged on the media surface can readily be removed from the media surface in the vicinity of the nozzles from which the gas has been blown-out, so that the gas is not required to travel a larger distance in parallel with the support and transport surface towards the edges of the array. Consequently, the gas flow rate per surface area of the media can be increased significantly without producing a high-velocity gas current (cross flow) that flows over the media surface and tends to dislocate or lift the media on the support and transport surface. This is particularly advantageous in case of a cut sheet printer in which a high-velocity gas current would significantly increase the risk that the edges of the media sheets, in particular the leading and trailing edges, are lifted off from the support and transport surface or the sheets are caused to cockle.

Another advantage is that the momentum of the gas that impinges on the media and is then deflected into the vent openings create a force that assists in firmly holding the media on the support and transport surface and thereby contributes to a safe media transport. Combined with the absence of a high-velocity gas current (cross flow) it is even possible to transport media without the need for vacuum attraction holding the media on a media conveyer (e.g. a belt).

Moreover, the evenly distributed vent openings improve the energy efficiency of the gas impingement unit because the gas that is flowing off from the surface of the media experiences a significantly smaller flow resistance that has to be overcome by the gas source.

As a result of these advantageous effects, the flow rate of the gas or hot air per surface of the media, and hence the intensity of the curing or drying effect, can be increased significantly without producing higher energy losses and without compromising the transport of the media.

More specific optional features of the invention are indicated in the dependent claims.

In one embodiment, the nozzles may be arranged in parallel rows, and the vent openings may be formed by gaps or slots that separate the rows of nozzles. In this way, the gas from the gas source can be efficiently supplied to the nozzles via supply lines that extend along the rows, and nevertheless a vent opening will be present in the immediate vicinity of each nozzle.

In particular in case of a cut sheet printer, it may be advantageous that the rows of nozzles and the vent openings extend in parallel with the transport direction of the media sheets. This reduces the risk of paper jams that could otherwise be caused by events in which a leading edge of a sheet gets caught in one of the gaps or slots that constitute the vent openings.

The rows of nozzles may be formed in a comb-like structure of parallel distribution lines that are connected to a common supply line which, if the distribution lines extend in transport direction of the media, will extend in transverse direction. The supply line may be arranged in a position sufficiently elevated from the support and transport surface so that it will not constitute an obstacle for the gas that exits through the vent openings.

In one embodiment, the vent openings may be connected to one or more suction devices by which the gas is actively withdrawn from the media surface. A particularly energy-efficient gas circulation system can be formed by recirculating the gas that has been withdrawn from the vent openings directly into the gas source.

Embodiment examples will now be described in conjunction with the drawings, wherein:

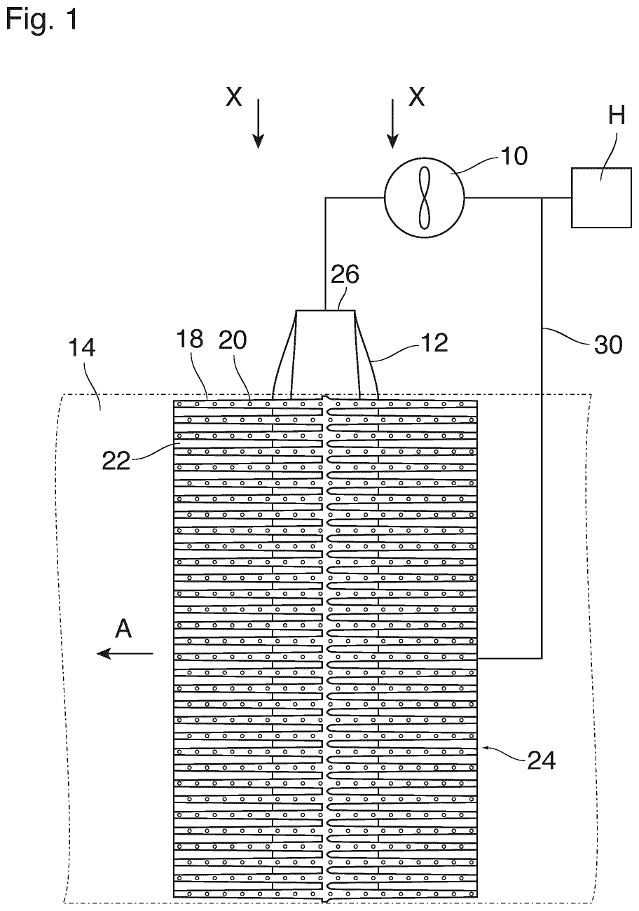

FIG. 1 is a bottom view of a gas impingement unit according to the invention

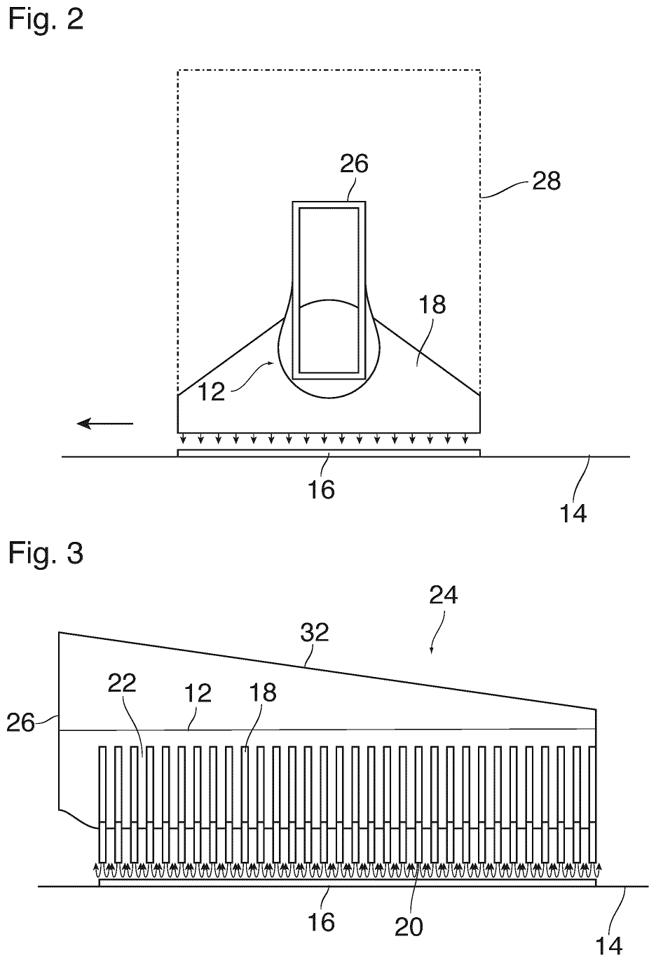

FIG. 2 is a schematic side view of the gas impingement unit shown in FIG. 1; and

FIG. 3 is a schematic front view of the gas impingement unit.

As is shown in FIG. 1, a gas source 10 is connected to a supply line 12 that extends transversely over a support and transport surface 14 that is arranged for supporting media sheets 16 (FIG. 2) and advancing them in a transport direction that has been indicated by an arrow A. The support and transport surface 14, which has only been shown in phantom lines in FIG. 1, may be constituted by an endless conveyor belt, preferably a perforated belt that runs over a suction box, so that the media sheets may safely be held in position on the conveyor by a vacuum attraction. The supply line 12 is connected to a number of parallel distribution lines 18 that extend in the transport direction A and each have a number of nozzles 20 that are evenly spaced along the distribution line 18. The distribution lines 18 are separated from one another by gaps that constitute vent openings 22 to which gas that has been jetted out from the nozzles 20 and has impinged on the media sheets can readily escape in the direction normal to the support and transport surface 14, so that the gas does not have to travel a large distance in parallel to the support and transport surface 14. Together, the nozzles 20 of the various distribution lines 18 and the vent openings 22 between these distribution lines constitute an interleaved array 24 of nozzles and vent openings that covers a rectangular surface area above the support and transport surface 14.

The gas source 10 may be constituted for example by a blower that is connected to an air heater H, so that hot air is displaced with a certain pressure into the supply line 12 and further into the distribution lines 18. The array 24 will be disposed above a portion of the support and transport surface 14 downstream of an ink jet print engine where images are printed onto the media sheets that are conveyed in the transport direction A. Then, when a media sheet on which an image has just been printed and which therefore still has a wet surface reaches the array 24, the ink (e. g. a water-based ink) will be cured and dried by the hot air that is blown out from the nozzles 20 and impinges onto the surface of the media sheet. Since the nozzles 20 formed in the various distribution lines 18 are evenly distributed over the area of the array 14, a curing treatment will uniformly be applied to the entire surface of the media sheets. In the example shown, the nozzles 20 formed in two neighboring distribution lines 18 are staggered relative to one another, so that a particularly even distribution of the nozzles is achieved.

As can be seen in FIG. 2, the supply line 12 has an essentially circular cross-section over its entire length and has at one end (the top end in FIG. 1) a connector 26 with which it is connected to the gas source 10. In the example shown, the connector 26 has a rectangular cross-section and merges into a rectangular duct 32 (FIG. 3) that extends along the top of the supply line 12 and opens out into the lower part of the supply line which has the circular cross-section and from which the distribution lines 18 branch-off.

As can further be seen in FIG. 2, the distribution lines 18 have a triangular shape when seen in a side view, with the height being largest at the center of the supply line 12, and the cross-section of the supply lines tapering towards the opposite ends, so that an essentially uniform flow of gas through the nozzles 20 is obtained. The nozzles 20 are not visible in FIG. 2 because they are formed in a bottom or base wall of each of the distribution lines 18. However, the jets of air exiting from the nozzles 20 have been symbolized by arrows in FIG. 2.

As has been shown in dot-dashed lines in FIG. 2, the array 24 of nozzles and vent openings (gaps between the distribution lines 18) forms the bottom of a suction box 28 that is connected to the suction side of the gas source 10 (blower) by a line 30 shown in FIG. 1. Thus, the blower draws-in air from the suction box 28 and thereby assists the withdrawal of air through the vent openings 22. The air that has been withdrawn from the suction box 28 via the line 30 is recirculated into the blower (gas source 10) and is mixed with hot air from the air heater H. The proportions of hot air and recirculated air are adjusted such that the hot air replaces losses that are caused by the outflow of air at the peripheral edges of the array 24. Since, in this way, part of the air that exits from the nozzles 20 is replaced by dry hot air from the heater H, the humidity content of the air that is jetted out from the nozzles 20 can be controlled.

FIG. 3 shows the array 24 in a front view, so that one side the comb-like structure of distribution lines 18 and vent openings 22 formed there between is visible. The flows of air that exit from the nozzles 20, impinge on the media sheet 16 and are then withdrawn through the vent openings 20 has been symbolized by arrows. As can further be seen in FIG. 3, the rectangular duct 32 that adjoins the connector 26 tapers towards the opposite end of the supply line 12, so that the air is uniformly distributed over the sequence of distribution lines 18.

1. A gas impingement unit comprising a gas source and an array of nozzles connected to the gas source and directed onto a support and transport surface arranged for supporting sheet-or web-like media and moving them in a transport direction (A) past the array of nozzles,
wherein the nozzles are evenly distributed over an area of the support and transport surface,
wherein said array is an array of interleaved nozzles and vent openings,
wherein the vent openings are arranged for allowing gas that has been blown out from the nozzles to escape in a direction normal to the support and transport surface,
wherein the nozzles in the array are arranged in parallel rows and the vent openings extend in parallel with the rows of nozzles and are interleaved with these rows such that each row of nozzles has at least one vent opening as its neighbor, and
wherein the rows of nozzles extend in the transport direction (A).

2. The gas impingement unit according to claim 1, wherein the nozzles of each row are formed in a distribution line, the array comprising at least six distribution lines that extend in parallel to one another, and
wherein the vent openings are formed by gaps between the distribution lines.

3. The gas impingement unit according to claim 2, wherein each distribution line forms exactly one row of nozzles.

4. The gas impingement unit according to claim 2, wherein each distribution line forms a plurality of rows of nozzles.

5. The gas impingement unit according to claim 2, wherein the distribution lines extend to opposite sides from a supply line.

6. The gas impingement unit according to claim 5, wherein the supply line is common to all distribution lines and extends in a direction orthogonal to the distribution lines.

7. The gas impingement unit according to claim 6, wherein a distance between a position at which the distribution lines are connected to the supply line and the support and transport surface is larger than the distance between the nozzles and the support and transport surface.

8. The gas impingement unit according to claim 7, wherein the distribution lines have a triangular contour when seen in a side view and taper towards the ends that are remote from the supply line.

9. The gas impingement unit according to claim 1, wherein a suction device is provided for assisting the flow of air through the vent openings.

10. The gas impingement unit according to claim 3, wherein the distribution lines extend to opposite sides from a supply line.

11. The gas impingement unit according claim 4, wherein the distribution lines extend to opposite sides from a supply line.

12. The gas impingement unit according to claim 10, wherein the supply line is common to all distribution lines and extends in a direction orthogonal to the distribution lines.

13. The gas impingement unit according to claim 11, wherein the supply line is common to all distribution lines and extends in a direction orthogonal to the distribution lines.

14. The gas impingement unit according to claim 12, wherein a distance between a position at which the distribution lines are connected to the supply line and the support and transport surface is larger than the distance between the nozzles and the support and transport surface.

15. The gas impingement unit according to claim 13, wherein a distance between a position at which the distribution lines are connected to the supply line and the support and transport surface is larger than the distance between the nozzles and the support and transport surface.

16. The gas impingement unit according to claim 14, wherein the distribution lines have a triangular contour when seen in a side view and taper towards the ends that are remote from the supply line.

17. The gas impingement unit according to claim 15, wherein the distribution lines have a triangular contour when seen in a side view and taper towards the ends that are remote from the supply line.

18. The gas impingement unit according to claim 1, wherein the nozzles of each row are formed in a distribution line, the array comprising at least twelve distribution lines that extend in parallel to one another, and
wherein the vent openings are formed by gaps between the distribution lines.

19. The gas impingement unit according to claim 1, wherein a suction device is provided for assisting the flow of air through the vent openings and recirculating the withdrawn air to the gas source.
